(19) United States
(12) Patent Application Publication
(10) Pub. No.: US 2010/0254159 A1
(43) Pub. Date: Oct. 7, 2010

(54) BRIGHTNESS ENHANCEMENT FILM AND BACKLIGHT MODULE

(75) Inventors: Tun-Chien Teng, Hsin-Chu (TW); Chih-Jen Tsang, Hsin-Chu (TW); Neng-Jung Tseng, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/631,798

(22) Filed: Dec. 4, 2009

(30) Foreign Application Priority Data
Apr. 7, 2009 (TW) 98111496

(51) Int. Cl. F21V 7/04; F21S 8/10

(52) U.S. Cl. 362/608; 362/317

(57) ABSTRACT

A brightness enhancement film (BEF) including a first surface, a second surface, and a side surface is provided. The first surface is a curved surface continuously fluctuant in two dimensions and includes a plurality of axisymmetric convex surfaces and a plurality of non-axisymmetric concave surfaces. Each of the axisymmetric convex surfaces is a curved surface. The axisymmetric convex surfaces and the non-axisymmetric concave surfaces are arranged alternately in the two dimensions and respectively form a plurality of wave crests and a plurality of wave troughs. Each of the non-axisymmetric concave surfaces is a curved surface. The second surface is opposite to the first surface and the side surface connects the first surface and the second surface. In addition, a backlight module employing the BEF is also provided.

### CROSS-REFERENCE TO RELATED APPLICATION

This application claims the priority benefit of Taiwan application serial no. 98111496, filed Apr. 7, 2009. The entirety of the above-mentioned patent application is hereby incorporated by reference herein and made a part of specification.

### BACKGROUND OF THE INVENTION

1. Field of the Invention

The invention generally relates to an optical film and a light source module, and more particularly, to a brightness enhancement film (BEF) and a backlight module.

2. Description of Related Art

FIG. 1A is a cross-sectional diagram of a conventional backlight module and FIG. 1B is a three-dimensional diagram of a prism sheet of the backlight module in FIG. 1A. Referring to FIGS. 1A and 1B, a conventional backlight module 40 includes a reflective sheet 50, a light guide plate (LGP) 60, a bottom diffuser 70a, a prism sheet 80, and a top diffuser 70b sequentially disposed from the back side to the front side of the backlight module 40. The LGP 60 has a first surface 62, a second surface 64 opposite to the first surface 62, and a light incident surface 66 connecting the first surface 62 and the second surface 64. A cold cathode fluorescent lamp (CCFL) 90 is disposed at a side of the light incident surface 66, wherein the CCFL 90 is capable of emitting a light beam 92 entering the LGP 60 via the light incident surface 66.

A part of the light beam 92 is diffused by a plurality of diffusion dots 68 and then strikes onto the reflective sheet 50. The light beam 92 is reflected by the reflective sheet 50 onto the bottom diffuser 70a, and travels to the prism sheet 80. On the other hand, another part of the light beam 92 is diffused by the diffusion dots 68 and then directly strikes onto the bottom diffuser 70a and reaches the prism sheet 80.

The prism sheet 80 includes a transparent substrate 82 and a plurality of prism rods 84 disposed on the transparent substrate 82, wherein each of the prism rods 84 extends along a first direction D1 and the prism rods 84 are arranged along a second direction D2. The prism rods 84 give the incident light beam 92 with different incident angles different optical actions, i.e., the prism rods 84 allow the incident light beam 92 with an incident angle within a specific angle range to pass through and make the light beam 92 emitted from the prism sheet 80 perpendicular to the top diffuser 70b to the utmost extent so as to achieve a light-collecting effect by the prism sheet 80. In this way, the backlight module 40 provides a surface light source with more concentrate light-emitting angles. For example, the light 92a in the light beam 92 passes through the prism rods 84 to reach the top diffuser 70b, while the light 92b and the light 92c in the light beam 92 are respectively reflected back by the prism side surfaces 84a and 84b of the prism rods 84 onto the reflective sheet 50. The reflective sheet 50 then reflects back the light 92b and the light 92c to the prism sheet 80, so that the light 92b and the light 92c are recycled for usage. Moreover, the prism rods 84 allow a part of the recycled light beam 92 passing through, and reflect another part of the recycled light beam 92 again. The above-mentioned travel cycles of the partial light beam 92 between the prism rods 84 and the reflective sheet 50 performed many times, until the light is able to pass through the prism rods 84 with an incident angle close to the incident angle of the light 92a.

When the backlight module 40 does not employ the top diffuser 70b and the bottom diffuser 70a, the surfaces of the prism rods 84 are plane ones, and the plane surfaces are unable to mask the diffusion dots 68 or defects on the LGP 60 and thereby unable to cause the diffusion dots 68 blurry. At the time, the surface light source provided by the backlight module 40 is not uniform. Moreover, the profiles (the crest lines L1 and the boundary lines L2 between every two adjacent prism rods 84) of the prism rods 84 are distinguished, and make moiré pattern and Newton rings easily formed by the pixel array (not shown) of the liquid crystal panel (LCD) disposed over the backlight module 40 and the prism rods 84. Therefore, the above-mentioned conventional backlight module 40 without top diffuser 70b and the bottom diffuser 70a makes the display frame of an LCD ununiform.

Although the above-mentioned problem may be solved by adding the top diffuser 70b and the bottom diffuser 70a, but the design may increase the cost and the light loss, in particular, increase the thickness of the backlight module 40. Besides, the sharp crest lines L1 of the prism rods 84 easily cause scratch between the prism sheet 80 and the films (for example, the top diffuser 70b) adjacent to the prism sheet 80. The recycle mechanism for the maximum usage of the light beam 92 makes the reflective sheet 50, the LGP 60, the bottom diffuser 70a, the prism sheet 80 or the top diffuser 70b absorb more light energy, and results in increasing light loss and a lower light efficiency of the backlight module 40.

### SUMMARY OF THE INVENTION

Accordingly, the invention is directed to a brightness enhancement film (BEF) having good light-concentrating characteristic and good masking characteristic.

The invention is also directed to a backlight module capable of providing a surface light source with less light-emitting angles and even luminance.

An embodiment of the invention provides a BEF including a first surface, a second surface, and a side surface. The first surface is a curved surface continuously fluctuant in two dimensions and includes a plurality of axisymmetric convex surfaces and a plurality of non-axisymmetric concave surfaces. Each of the axisymmetric convex surfaces is a curved surface. The axisymmetric convex surfaces and the non-axisymmetric concave surfaces are arranged alternately in the two dimensions and respectively form a plurality of wave crests and a plurality of wave troughs. Each of the non-axisymmetric concave surfaces is a curved surface. The second surface is opposite to the first surface and the side surface connects the first surface and the second surface.

Another embodiment of the invention provides a backlight module including an above-mentioned BEF and at least a light-emitting component. The light-emitting component is adapted to emit a light beam and the BEF is disposed in the transmission path.

The embodiment or the embodiments of the invention may have at least one of the following advantages, in the BEF of the embodiments of the invention, the axisymmetric convex surfaces are capable of producing good light-concentrating effect and the non-axisymmetric concave surfaces are capable of producing good light-diffusing effect, wherein the good light-diffusing effect further produces good masking characteristic. By making the axisymmetric convex surfaces and the non-axisymmetric concave surfaces arranged alternately in the two dimensions, the BEF provided by the embodiments of the invention may have both good light-concentrating characteristic and good masking characteristic. In this way, the backlight module provided by the embodiments of the invention is able to provide a surface light source with smaller light-emitting angles and more uniform luminance.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional diagram of a conventional backlight module.

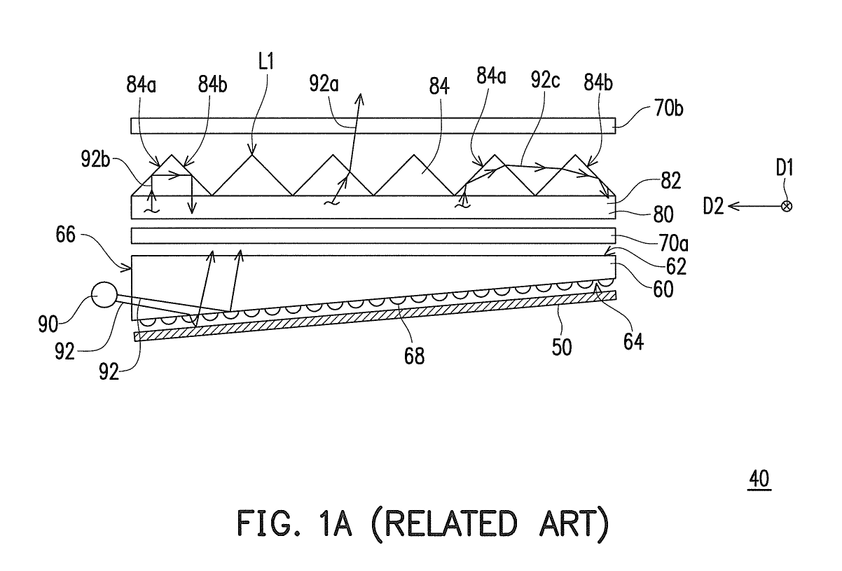

FIG. 1B is a three-dimensional diagram of a prism sheet of the backlight module in FIG. 1A.

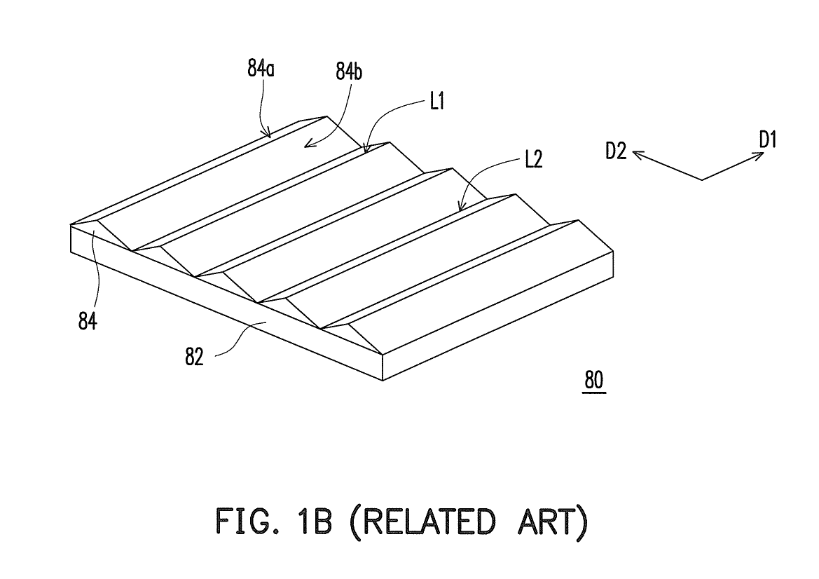

FIG. 2 is a three-dimensional diagram of a backlight module according to the embodiment of the invention.

FIG. 3 is a cross-sectional diagram of the backlight module along line I-I in FIG. 2.

FIG. 4 is a cross-sectional diagram of the brightness enhancement film (BEF) along line II-II in FIG. 2.

FIG. 5 is a three-dimensional diagram of a structure formed by cutting out the BEF of FIG. 2 along the edge of a minimum unit region.

FIG. 6 is a diagram of the structure on the first surface in FIG. 2 projected on the second surface of the BEF.

FIG. 7 is a graph showing three luminance distributions of the light emitted from a BEF of the embodiment, a Lambertian light source and a conventional prism sheet over light emitting angles.

FIG. 8 is a diagram of the structure of the BEF of another embodiment of the invention on the first surface projected on the second surface of the BEF.

FIG. 9 is a cross-sectional diagram of a backlight module according to another embodiment of the invention.

DESCRIPTION OF THE EXEMPLARY EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

In this patent specification, so-called “an object is axisymmetric” means that there exists a symmetric axis, and around the symmetric axis the object rotates by any angle and the outline of the object after the above-mentioned rotation is substantially the same as the outline of the object before the rotation. In addition, so-called “an object is non-axisymmetric” means that there exists no symmetric axis, around which the object rotates by any angle and the outline of the object after the above-mentioned rotation is substantially the same as the outline thereof before the rotation.

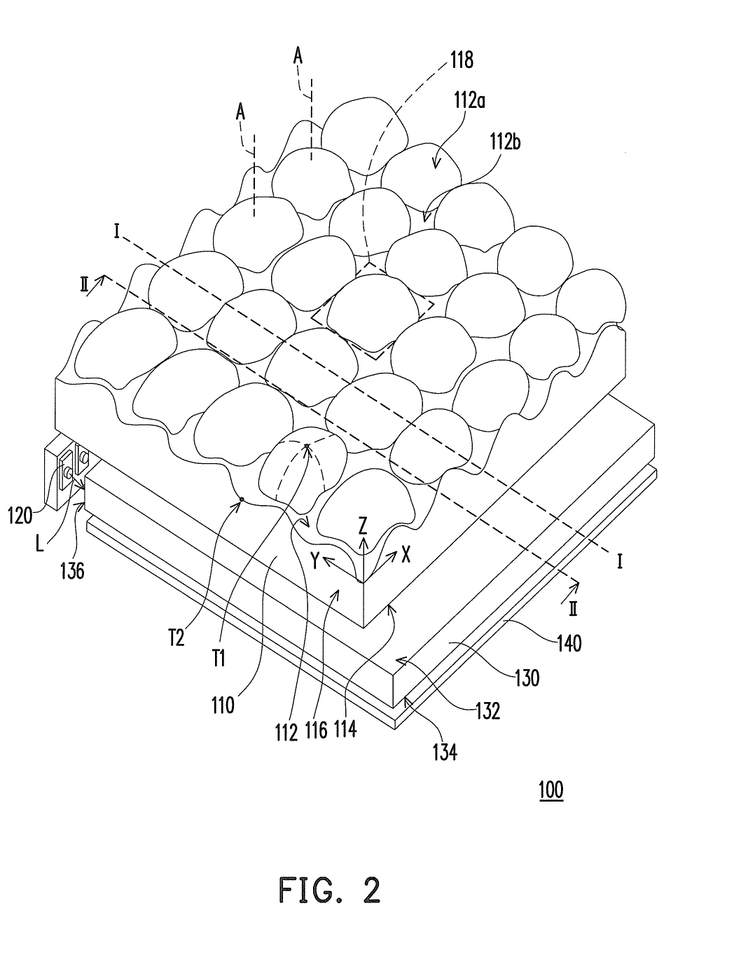

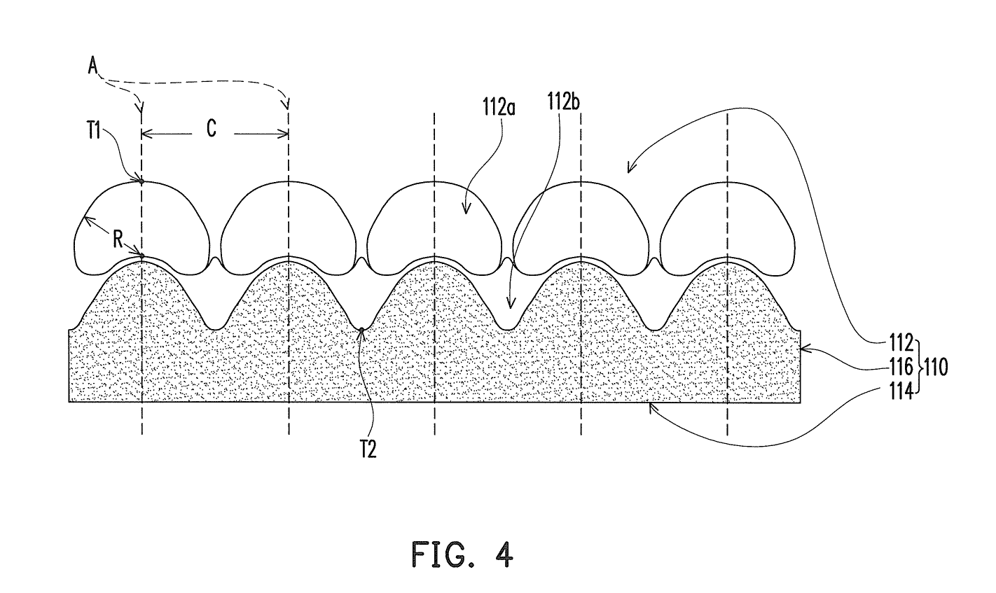

Referring to FIGS. 2, 3 and 4, a backlight module 100 of this embodiment includes a brightness enhancement film (BEF) 110 and a plurality of light-emitting components 120. The BEF 110 includes a first surface 112, a second surface 114, and a side surface 116, wherein the second surface 114 is opposite to the first surface 112, and the side surface 116 connects the first surface 112 and the second surface 114. Each of the light-emitting components 120 is adapted to emit a light beam L and the BEF 110 is disposed in the transmission path of the light beam L. In the embodiment, both the first surface 112 and the second surface 114 are located in the transmission path of the light beam L and, in particular, the second surface 114 is located in the transmission path of the light beam L between the light-emitting components 120 and the first surface 112. In the embodiment, each of the light-emitting components 120 is, for example, a light emitting diode (LED). However, in other embodiments, the light-emitting components 120 may be a cold cathode fluorescent lamp (CCFL) instead of the LEDs.

In the embodiment, the backlight module 100 further includes a light guide plate (LGP) 130 and a reflective sheet 140. The LGP 130 has a surface 132, a surface 134 opposite to the surface 132 and a light incident surface 136 connecting the surface 132 and the surface 134. The reflective sheet 140 is disposed at a side of the surface 134. The light-emitting components 120 are adapted to emit a light beam L. In the embodiment, the light beam L enters the LGP 130 from the light incident surface 136 and then reaches the BEF 110 via the surface 132. Specially, a part of the light beam L is under the action of a optical micro-structure 138 disposed on the LGP 130 and then goes to the reflective sheet 140, and the reflective sheet reflects the light beam L onto the surface 132. Further, the part of the light beam L reaches the BEF 110 from the surface 132. Another part of the light beam L is operated by the optical micro-structure 138 on the LGP 130 and then strikes onto the BEF 110. In the embodiment, the optical micro-structure 138 is a plurality of diffusion dots located on the surface 134 and the diffusion dots are, for example, convex spots. In other embodiments, the optical micro-structure 138 is concave spots, convex strips or concave strips as well. Besides, in other embodiments, the optical micro-structure 138 is located on the surface 132.

The first surface 112 is a curved surface continuously fluctuant in two dimensions and includes a plurality of axisymmetric convex surfaces 112a and a plurality of non-axisymmetric concave surfaces 112b. Each of the axisymmetric convex surfaces 112a is a curved surface. In the embodiment, the second surface 114 is, for example, a plane surface. In addition, in the embodiment, each of the axisymmetric convex surfaces 112a is axisymmetric about a symmetric axis A and the symmetric axes A of the axisymmetric convex surfaces 112a are substantially parallel to each other. In the embodiment, the symmetric axes A of the axisymmetric convex surfaces 112a are substantially perpendicular to the second surface 114 as well. In the embodiment, each of the axisymmetric convex surfaces 112a is, for example, a spherical surface. However, in other embodiments, each of the axisymmetric convex surfaces 112a is an ellipsoid surface or other axisymmetric curve surfaces.

The axisymmetric convex surfaces 112a and the non-axisymmetric concave surfaces 112b are arranged alternately in the two dimensions and respectively form a plurality of wave crests and a plurality of wave troughs, and each of the non-axisymmetric concave surfaces 112b is a curved surface. In the embodiment, each of the non-axisymmetric concave surfaces 112b is, for example, a two-dimensional sinusoidal curved surface. For example, the two-dimensional sinusoidal curved surface is expressed by the following formula:

z=A₁ sin(k₁x)+A₂ sin(k₂y)

wherein, x, y and z respectively have a coordinate direction as shown in FIG. 2, and A₁, A₂, k₁ and k₂ are constants. In other embodiments, each of the non-axisymmetric concave surfaces 112b is a two-dimensional sinusoidal curved surface expressed by other formulas or other forms of non-axisymmetric concave surface.

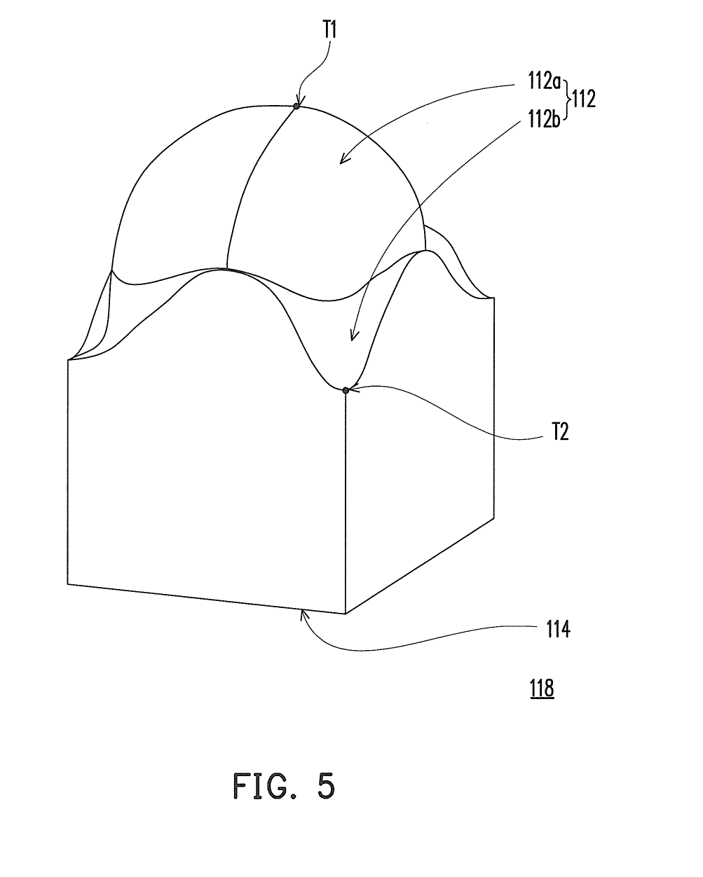

Referring to FIGS. 2, 5 and 6, in the embodiment, the first surface 112 is a curved surface continuously fluctuant in two dimensions and may be divided into a plurality of minimum unit regions 118, wherein the curved surfaces in the minimum unit regions 118 are substantially the same as each other. Each of the minimum unit regions 118 includes one of the axisymmetric convex surfaces 112a. The ratio of the area of the orthogonal projection of the axisymmetric convex surface 112a on the second surface 114 over the area of the orthogonal projection of the minimum unit region 118 on the second surface 114 falls in a range between 0.3 and 0.85. In other words, the ratio of the areas of the orthogonal projections of the axisymmetric convex surfaces 112a on the second surface 114 over the area of the orthogonal projection of the first surface 112 on the second surface 114 falls in a range between 0.3 and 0.85.

In the embodiment, the orthogonal projections of the vertexes T1 of the axisymmetric convex surfaces 112a on the second surface 114 are a plurality of first orthogonal projection points P1, the orthogonal projections of the most-concave points T2 of the non-axisymmetric concave surfaces 112b on the second surface 114 are a plurality of second orthogonal projection points P2, and the orthogonal projections of the edges of the axisymmetric convex surfaces 112a on the second surface 114 are a plurality of projected curves U. In the embodiment, the axisymmetric convex surfaces 112a are spherical surfaces, and thus the projected curves U are circles. The first orthogonal projection points P1 and the second orthogonal projection points P2 are arranged alternately on a plurality of first reference lines S1 substantially parallel to each other and are arranged alternately on a plurality of second reference lines S2 substantially parallel to each other as well, wherein each of the first reference lines Si is substantially perpendicular to each of the second reference lines S2. The first orthogonal projection points P1 are arranged on a plurality of third reference lines S3 substantially parallel to each other and are arranged on a plurality of fourth reference lines S4 substantially parallel to each other as well, wherein each of the third reference lines S3 is substantially perpendicular to each of the fourth reference lines S4. The second orthogonal projection points P2 are arranged on a plurality of fifth reference lines S5 substantially parallel to each other and are arranged on a plurality of sixth reference lines S6 substantially parallel to each other as well, wherein each of the fifth reference lines S5 is substantially perpendicular to each of the sixth reference lines S6. Each of the third reference lines S3 substantially has an included angle of 45° with each of the first reference lines S1, and each of the fifth reference lines S5 substantially has an included angle of 45° with each of the first reference lines S1.

In the backlight module 100 of the embodiment, the axisymmetric convex surfaces 112a produces good light-concentrating effect and the non-axisymmetric concave surfaces 112b produces good light-diffusing effect, wherein the good light-diffusing effect results in good masking characteristic to mask the optical micro-structure 138 on the LGP 130 and causing the optical micro-structure 138 blurry. In particular, by alternately arranging the axisymmetric convex surfaces 112a and the non-axisymmetric concave surfaces 112b in the two dimensions, the BEF 110 provided by the embodiment of the invention has both good light-concentrating characteristic and good masking characteristic, so that the backlight module 100 according to the embodiment of the invention provides a surface light source with smaller light-emitting angles and more uniform luminance.

Since the light-concentrating effect of the BEF 110 of the embodiment is obtained based on the refraction action of the axisymmetric convex surfaces 112a on the light beam L, unlike the prior art the light beam cyclically travelling many times between prism rods and a reflective sheet, so that the design by using the BEF 110 reduces light loss and thereby promote the light efficiency of the backlight module 100. Moreover, the good masking effect obtained through the light-diffusing characteristic of the non-axisymmetric concave surfaces 112b may further exempt employing an additional top diffuser in the backlight module 100, even may exempt employing an additional bottom diffuser too, and thus contributes to effectively reduce the thickness of the backlight module 100, saves fabrication cost and reduces light loss.

In order to further increase the light-concentrating effect of the BEF 110 of the embodiment, the ratio of the curvature radius R of each of the axisymmetric convex surfaces 112a over the pitch C of the axisymmetric convex surfaces 112a falls in a range between 0.25 and 0.65 by design. If the BEF is designed to make the whole first surface 112 of the BEF a sinusoidal curved surface, the curvature radiuses near to the inflection points on the cross-section of the sinusoidal curved surface perpendicular to the second surface 114 would approach infinity, so that no light-concentrating effect is obtained. Contrarily, in the BEF 110 of the embodiment, when the pitch C is fixed, the curvature radiuses R of the axisymmetric convex surfaces 112a fall in a range of certain values without having a risk of approaching infinity, so that the whole axisymmetric convex surfaces 112a are able to provide light-concentrating effect.

The proportion of the light-concentrating effect extent and the light-diffusing effect extent of the BEF 110 of the embodiment may be controlled by adjusting the ratio of the areas of the axisymmetric convex surfaces 112a over the areas of the non-axisymmetric concave surfaces 112b. For example, in the embodiment, the ratio of the area of the orthogonal projection of the axisymmetric convex surface 112a on the second surface 114 over the area of the orthogonal projection of the minimum unit region 118 on the second surface 114 is designed to fall in a range between 0.3 and 0.85, in other words, the ratio of the areas of the orthogonal projections of the axisymmetric convex surfaces 112a on the second surface 114 over the area of the orthogonal projection of the first surface 112 on the second surface 114 falls in a range between 0.3 and 0.85. In this way, the BEF 110 of the embodiment has both good light-concentrating effect and good masking effect.

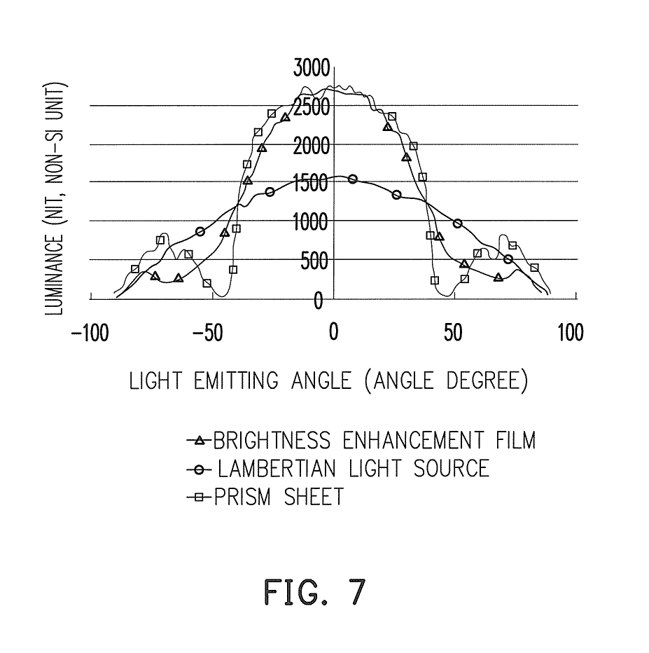

An optical simulation is performed to verify the advantage of the BEF 110 of the embodiment. In embodiment, the Lambertian light source is, for example, LEDs. Referring to FIG. 7, the ordinate represents luminance and the abscissa represents light emitting angle, corresponding to the light emitting angle near to 0°, the luminance of the light emitted from the BEF 110 of the embodiment is close to the luminance of the light emitted from the conventional prism sheet, in other words, the positive gain of the BEF 110 of this embodiment with respect to the light source (for example, a Lambertian light source) is close to the positive gain of the conventional prism sheet with respect to the light source. Corresponding to the light emitting angle near to 40°, the luminance of the light emitted from the BEF 110 of the embodiment is much grater than the luminance of the light emitted from the conventional prism sheet, i.e., the light with the light emitting angles near to 40° may be used, so that the backlight module 100 employing the BEF 110 of the embodiment has better light efficiency than the light efficiency of the backlight module employing the prior art prism sheet. On the other hand, corresponding to the light emitting angle near to 70°, although the luminance of the light emitted from the conventional prism sheet is greater than the luminance of the light emitted from the BEF 110 of the embodiment, the light with the light emitting angles near to 70° may not be effectively used and the light loss is certain. In this regard, the backlight module 100 employing the BEF 110 of the embodiment generally has less light loss than the light loss of the backlight module employing the conventional BEF. According to the described above, the simulation proves the BEF 110 of the embodiment has better light-concentrating effect.

The graph obtained from the optical simulation in FIG. 7 does not limit the invention. In fact, in other embodiments or under other parameters, other optical simulation results with good light-concentrating effect may be obtained as well.

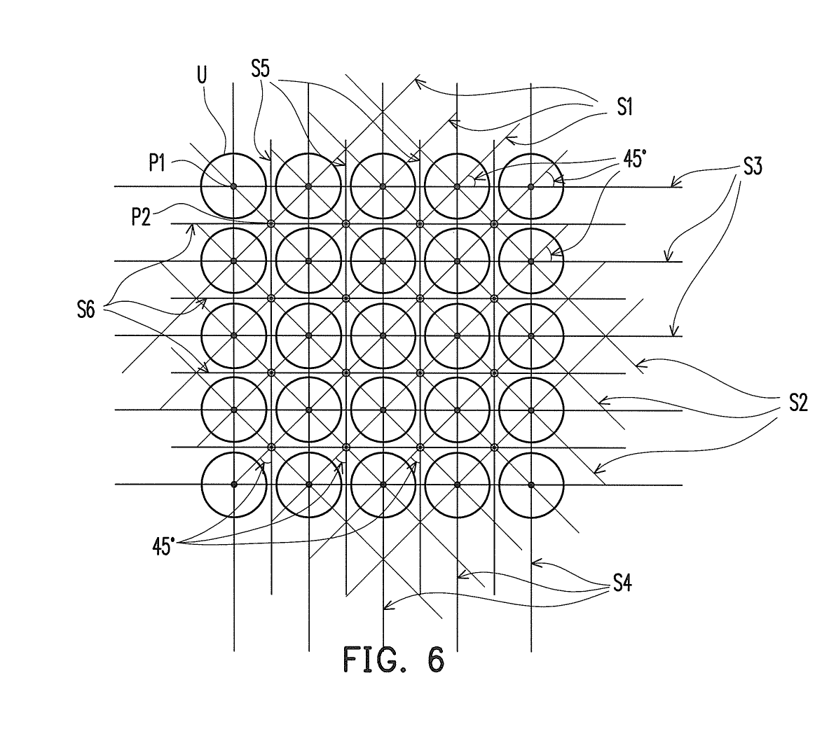

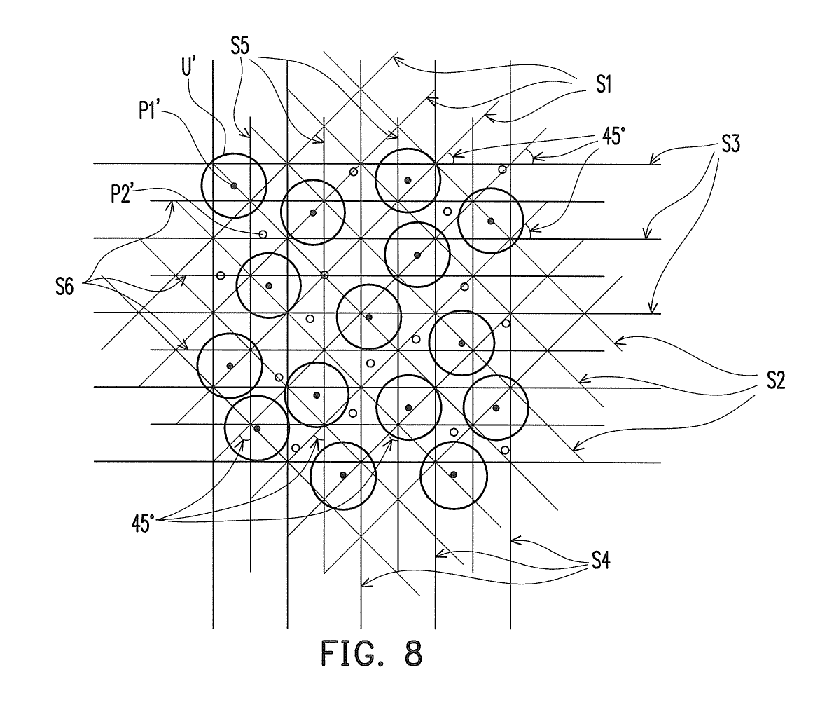

Referring to FIG. 8, the backlight module of the embodiment is similar to the above-mentioned backlight module 100 (as shown by FIGS. 2 and 6), except that in the BEF of the embodiment, the non-axisymmetric concave surface is an irregular curved surface, so that the positions of the second orthogonal projection points P2′ of the most-concave points of the non-axisymmetric concave surfaces have irregular distribution. Besides, the positions of the axisymmetric convex surfaces are also irregularly distributed, such that both the positions of the first orthogonal projection points P1′ of the vertexes of the axisymmetric convex surfaces and the positions of the projected curves U′ of the edges of the axisymmetric convex surfaces are irregularly distributed. In addition, the irregular distributions of the first orthogonal projection points P1′, the second orthogonal projection points P2′ and the projected curves U′ may be seen from the relative positions of the first reference line S1, the second reference line S2, the third reference line S3, the fourth reference line S4, the fifth reference line S5 and the sixth reference line S6, and all of the reference lines are the same as the reference lines in FIG. 6. Since the non-axisymmetric concave surfaces are irregular curved surfaces and the disposing positions of the axisymmetric convex surfaces are irregularly distributed, when an LCD panel or other periodically arranged structures are disposed on the backlight module of the embodiment, the moiré pattern or the Newton rings may be effectively avoided, and further promotes the uniformity of the display frame.

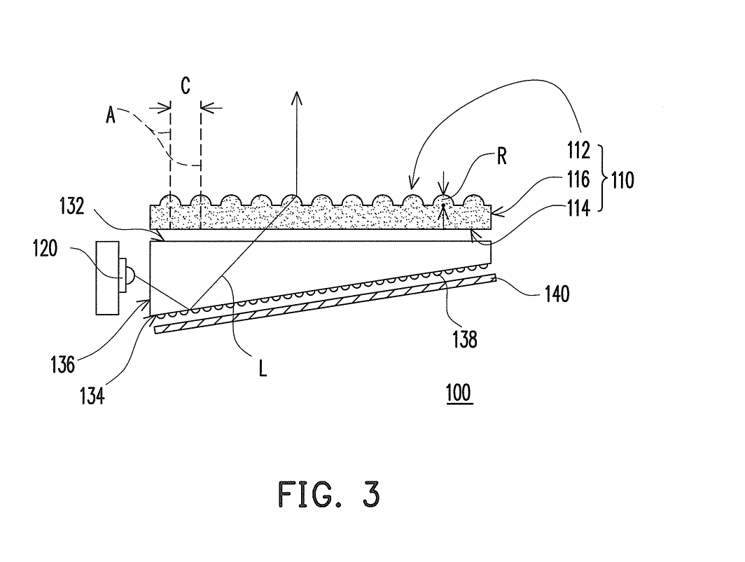

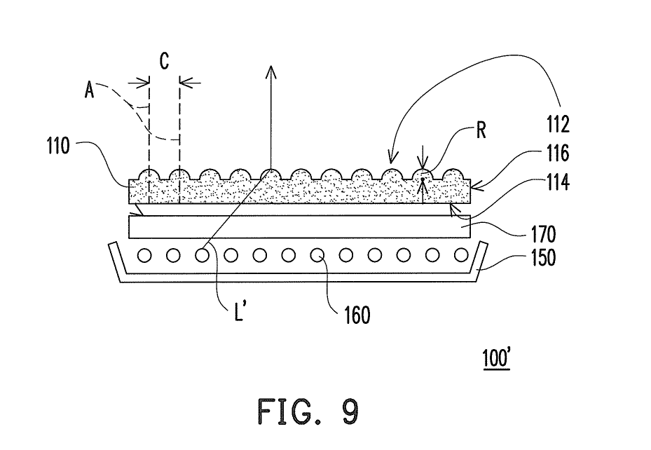

Referring to FIG. 9, the backlight module 100′ of the embodiment has a structure partially similar to the above-mentioned backlight module 100 (as shown by FIGS. 2 and 3), except that in the embodiment, the backlight module 100′ includes a light box 150, a plurality of light-emitting components 160 and a diffusion plate 170, wherein the light-emitting components 160A are, for example, a CCFL, but in other embodiments, the light-emitting components 160 may be LEDs. The light-emitting components 160 are disposed in the light box 150 and located between the diffusion plate 170 and the light box 150, and the diffusion plate 170 is disposed between the BEF 110 and the light-emitting components 160. The light beam L′ emitted from the light-emitting components 160 passes through the diffusion plate 170 and reaches the BEF 110.

In summary, the embodiment or the embodiments of the invention may have at least one of the advantages, in the BEF of the embodiments of the invention, the axisymmetric convex surfaces produces good light-concentrating effect and the non-axisymmetric concave surfaces produces good light-diffusing effect, wherein the good light-diffusing effect results in good masking characteristic. By alternately arranging the axisymmetric convex surfaces and the non-axisymmetric concave surfaces in the two dimensions, the BEF of the embodiments of the invention may have both good light-concentrating characteristic and good masking characteristic. As a result, the backlight module of the embodiments of the invention may provide a surface light source with more concentrate light-emitting angles and more uniform brightness.

Since the good light-concentrating effect of the BEF of the embodiment of the invention is obtained based on the refraction action of the axisymmetric convex surfaces on the light beam, unlike the prior art the light beam cyclically travelling many times between prism rods and a reflective sheet, so that the backlight module employing the BEF of the embodiments of the invention may keep the light loss less.

Moreover, since the non-axisymmetric concave surfaces of the BEF of the embodiments of the invention has good light diffusing characteristic and the BEF thereby has good masking characteristic, so that the backlight module saves the diffusers and further effectively reduces the thickness of the backlight module of the embodiments of the invention, and saves fabrication cost and reduces light loss.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A brightness enhancement film, comprising:
a first surface, wherein the first surface is a curved surface continuously fluctuant in two dimensions and comprises:
a plurality of axisymmetric convex surfaces, wherein each of the axisymmetric convex surfaces is a curved surface; and
a plurality of non-axisymmetric concave surfaces, wherein the axisymmetric convex surfaces and the non-axisymmetric concave surfaces are arranged alternately in the two dimensions and respectively form a plurality of wave crests and a plurality of wave troughs, and each of the non-axisymmetric concave surfaces is a curved surface;
a second surface, opposite to the first surface; and
a side surface, connecting the first surface and the second surface.

2. The brightness enhancement film as claimed in claim 1, wherein the first surface is a curved surface with periodically varied shape in the two dimensions, the first surface is divided into a plurality of minimum unit regions arranged in the two dimensions and the curved surfaces in the minimum unit regions are substantially the same as each other.

3. The brightness enhancement film as claimed in claim 2, wherein the ratio of the curvature radius of each of the axisymmetric convex surfaces over the pitch of the axisymmetric convex surfaces falls in a range between 0.25 and 0.65.

4. The brightness enhancement film as claimed in claim 2, wherein each of the minimum unit regions comprises one of the axisymmetric convex surfaces, and the ratio of the area of the orthogonal projection of each of the axisymmetric convex surfaces on the second surface over the area of the orthogonal projection of each of the minimum unit regions on the second surface falls in a range between 0.3 and 0.85.

5. The brightness enhancement film as claimed in claim 2, wherein each of the non-axisymmetric concave surfaces is a two-dimensional sinusoidal curved surface.

6. The brightness enhancement film as claimed in claim 1, wherein each of the axisymmetric convex surfaces is axisymmetric about a symmetric axis, the symmetric axes of the axisymmetric convex surfaces are substantially parallel to each other, and the symmetric axes are substantially perpendicular to the second surface.

7. The brightness enhancement film as claimed in claim 1, wherein each of the axisymmetric convex surfaces is a spherical surface or an ellipsoidal surface.

8. The brightness enhancement film as claimed in claim 1, wherein the ratio of the areas of the orthogonal projections of the axisymmetric convex surfaces on the second surface over the area of the orthogonal projection of the first surface on the second surface falls in a range between 0.3 and 0.85.

9. The brightness enhancement film as claimed in claim 1, wherein the orthogonal projections of vertexes of the axisymmetric convex surfaces on the second surface are a plurality of first orthogonal projection points, the orthogonal projections of most-concave points of the axisymmetric convex surfaces on the second surface are a plurality of second orthogonal projection points, the first orthogonal projection points and the second orthogonal projection points are arranged alternately on a plurality of first reference lines substantially parallel to each other and arranged alternately on a plurality of second reference lines substantially parallel to each other, each of the first reference lines is substantially perpendicular to each of the second reference lines, the first orthogonal projection points are arranged on a plurality of third reference lines substantially parallel to each other and on a plurality of fourth reference lines substantially parallel to each other, each of the third reference lines is substantially perpendicular to each of the fourth reference lines, the second orthogonal projection points are arranged on a plurality of fifth reference lines substantially parallel to each other and on a plurality of sixth reference lines substantially parallel to each other, each of the fifth reference lines is substantially perpendicular to each of the sixth reference lines, each of the third reference lines substantially has an included angle of 45° with each of the first reference lines, and each of the fifth reference lines substantially has an included angle of 45° with each of the first reference lines.

10. A backlight module, comprising:
a brightness enhancement film, comprising:
a first surface, wherein the first surface is a curved surface continuously fluctuant in two dimensions and comprises:
a plurality of axisymmetric convex surfaces, wherein each of the axisymmetric convex surfaces is a curved surface; and
a plurality of non-axisymmetric concave surfaces, wherein the axisymmetric convex surfaces and the non-axisymmetric concave surfaces are arranged alternately in the two dimensions and respectively form a plurality of wave crests and a plurality of wave troughs, and each of the non-axisymmetric concave surfaces is a curved surface;
a second surface, opposite to the first surface; and
a side surface, connecting the first surface and the second surface; and
at least a light-emitting component, adapted to emit a light beam, wherein the brightness enhancement film is disposed in the transmission path of the light beam.

11. The backlight module as claimed in claim 10, wherein the first surface is a curved surface with periodically varied shape in two dimensions, the first surface is divided into a plurality of minimum unit regions arranged in the two dimensions and the curved surfaces in the minimum unit regions are substantially the same as each other.

12. The backlight module as claimed in claim 11, wherein the ratio of the curvature radius of each of the axisymmetric convex surfaces over the pitch of the axisymmetric convex surfaces falls in a range between 0.25 and 0.65.

13. The backlight module as claimed in claim 11, wherein each of the minimum unit regions comprises one of the axisymmetric convex surfaces, and the ratio of the area of the orthogonal projection of each of the axisymmetric convex surfaces on the second surface over the area of the orthogonal projection of each of the minimum unit regions on the second surface falls in a range between 0.3 and 0.85.

14. The backlight module as claimed in claim 11, wherein each of the non-axisymmetric concave surfaces is a two-dimensional sinusoidal curved surface.

15. The backlight module as claimed in claim 10, wherein each of the axisymmetric convex surfaces is axisymmetric about a symmetric axis, the symmetric axes of the axisymmetric convex surfaces are substantially parallel to each other, and the symmetric axes are substantially perpendicular to the second surface.

16. The backlight module as claimed in claim 10, wherein each of the axisymmetric convex surfaces is a spherical surface or an ellipsoidal surface.

17. The backlight module as claimed in claim 10, wherein the ratio of the areas of the orthogonal projections of the axisymmetric convex surfaces on the second surface over the area of the orthogonal projection of the first surface on the second surface falls in a range between 0.3 and 0.85.

18. The backlight module as claimed in claim 10, wherein the orthogonal projections of vertexes of the axisymmetric convex surfaces on the second surface are a plurality of first orthogonal projection points, the orthogonal projections of the most-concave points of the axisymmetric convex surfaces on the second surface are a plurality of second orthogonal projection points, the first orthogonal projection points and the second orthogonal projection points are arranged alternately on a plurality of first reference lines substantially parallel to each other and arranged alternately on a plurality of second reference lines substantially parallel to each other, each of the first reference lines is substantially perpendicular to each of the second reference lines, the first orthogonal projection points are arranged on a plurality of third reference lines substantially parallel to each other and on a plurality of fourth reference lines substantially parallel to each other, each of the third reference lines is substantially perpendicular to each of the fourth reference lines, the second orthogonal projection points are arranged on a plurality of fifth reference lines substantially parallel to each other and on a plurality of sixth reference lines substantially parallel to each other, each of the fifth reference lines is substantially perpendicular to each of the sixth reference lines, each of the third reference lines substantially has an included angle of 45° with each of the first reference lines, and each of the fifth reference lines substantially has an included angle of 45° with each of the first reference lines.

19. The backlight module as claimed in claim 10, wherein both the first surface and the second surface are located in the transmission path of the light beam, and the second surface is located in the transmission path of the light beam between the light-emitting component and the first surface.
